(19) United States
(12) Patent Application Publication
(10) Pub. No.: US 2012/0162613 A1
(43) Pub. Date: Jun. 28, 2012

(54) PROJECTION APPARATUS

(75) Inventors: Chin-Ku Liu, Hsin-Chu (TW); Yu-Sung Lai, Hsin-Chu (TW)

(73) Assignee: CORETRONIC CORPORATION, Hsin-Chu (TW)

(21) Appl. No.: 13/239,452

(22) Filed: Sep. 22, 2011

(30) Foreign Application Priority Data
Dec. 28, 2010 (CN) 201010621654.8

(51) Int. Cl. G03B 21/14

(52) U.S. Cl. 353/31

(57) ABSTRACT

A projection apparatus including an illumination system, a light valve, and a projection lens is provided. The illumination system provides an illumination beam. The light valve is disposed on a transmission path of the illumination beam, and is used to convert the illumination beam into an image beam. The projection lens is disposed on a transmission path of the image beam and has a lens group, and the lens group includes a plurality of lenses. A lens of the lenses closest to the light valve has an optical axis, a first edge, and a second edge. The first edge and the second edge are located on opposite sides of the optical axis, and a ratio of a distance from the first edge to the optical axis and a distance from the second edge to the optical axis is greater than or equal to 0 and less than 1.

### CROSS-REFERENCE TO RELATED APPLICATION

This application claims the priority benefit of China application serial no. 201010621654.8, filed on Dec. 28, 2010. The entirety of the above-mentioned patent application is hereby incorporated by reference herein and made a part of this specification.

### BACKGROUND OF THE INVENTION

1. Field of the Invention

The invention relates to a projection apparatus, and more particularly, to a projection apparatus with small size and high projection quality.

2. Description of Related Art

In general, when a projection apparatus is projecting an image, a light valve will convert an illumination beam to an image beam and reflect the image beam into the projection lens. Then, the image beam is projected onto a screen through the projection lens. However, as projection apparatuses are getting thinner, the distance between each optical element in the projection apparatus will become smaller. Thus, when a light beam is transmitted within a projection apparatus, the projection apparatus is prone to have interference between the image beam and the optical elements because the optical elements are so close to each other, causing shadow on the projected image, making the projection apparatus low quality.

U.S. Pat. No. 7,724,436 discloses a projection engine. The projection engine at least includes a light tunnel, a collimator, a dichroic subassembly, a lens, a panel, an x-cube, and a projection lens. In order to decrease the volume of the projection engine, the edge of the lens closed to the center of the projection engine can be cut so as to reduce the possibility of interference between the lens and other optical elements.

U.S. Pat. No. 6,406,156 discloses a reflecting projection lens module. In the reflecting projection lens module, an intended light reflected by the light valve to the projection lens can be transmitted outside through a first mirror and a second mirror, and the portions of the first mirror and the second mirror not used to receive and reflect the intended light can be cut off, so as to reduce the size of the lens.

U.S. Pat. No. 6,008,951 discloses an illumination optical system. The illumination optical system includes a light source, collection lenses, a folding mirror, and a truncated lens. The truncated lens can prevent interference between the lenses.

U.S. Pat. No. 6,799,852 discloses a projector, wherein the projector includes a light source, a light reflecting cover, a color wheel, a light pipe, a relay lens, a reflecting lens, an elliptical mirror, a reflecting light valve, and a projection lens, wherein the elliptical mirror is used for reducing the size of the projector. However, the aforementioned conventional structures still have a limit on the overall size of the projection apparatus.

In general, in order to prevent interference in the illumination beam and the image beam between the relay lens and the projection lens, which results in a shadowy display, usually, the solution is to extend the transmission path of the illumination system, making a greater distance between the relay lens and the projection lens. This lowers the amount of interference in the illumination beam and the image beam between the relay lens and the projection lens. Or, the lens closest to the light valve is made with smaller dimensions (such as shortening the diameter of the lens) to avoid the relay lens and the projection lens being too close, and thus avoiding the problem of light beam interference. Even though adopting the mentioned method can solve the problem of interference created between the relay lens and the projection lens, the overall size of the projection apparatus is unable to effectively be reduced to achieve the goal of being a thin projection apparatus.

### SUMMARY OF THE INVENTION

The invention provides a projection apparatus with small size and also having high projection quality.

Other objects and advantages of the invention could be further illustrated by the technical features broadly embodied and described as follows.

In order to achieve one or a portion of or all of the objects or other objects, one embodiment of the invention provides a projection apparatus including an illumination system, a light valve, and a projection lens. The illumination system provides an illumination beam. The light valve is disposed on a transmission path of the illumination beam, and is used to convert the illumination beam into an image beam. The projection lens is disposed on a transmission path of the image beam and has a lens group, and the lens group includes a plurality of lenses. A lens of the lenses closest to the light valve has an optical axis, a first edge, and a second edge. The first edge and the second edge are located on opposite sides of the optical axis, and a ratio of a distance from the first edge to the optical axis and a distance from the second edge to the optical axis is greater than or equal to 0 and less than 1.

In an embodiment of the invention, the image beam deviates from the optical axis of the lens.

In an embodiment of the invention, the image beam deviates from the optical axis of the lens at an angle within a range of three degrees.

In an embodiment of the invention, the ratio of a distance from the first edge to the optical axis and a distance from the second edge to the optical axis is between 0.2 and 0.6.

In an embodiment of the invention, the image beam deviates from the optical axis of the lens and passes through a side of the lens, wherein the second edge is located on the side.

In an embodiment of the invention, the projection apparatus further includes a relay lens disposed on the transmission path of the illumination beam and located between the illumination system and the light valve. In an embodiment of the invention, the relay lens has an optical axis, a third edge, and a fourth edge. The third edge and the fourth edge are located on opposite sides of the optical axis of the relay lens, and a ratio of a distance from the third edge to the optical axis of the relay lens and a distance from the fourth edge to the optical axis of the relay lens is greater than or equal to 0 and less than 1. In an embodiment of the invention, the ratio of a distance from the third edge to the optical axis and a distance from the fourth edge to the optical axis is between 0.4 and 0.5. In an embodiment of the invention, the third edge and the first edge are opposite to each other.

In an embodiment of the invention, the projection apparatus further includes a reflective element disposed on the transmission path of the illumination beam and located between the illumination system and the light valve, wherein the reflective element is used to transmit the illumination beam of the illumination system to the light valve.

In an embodiment of the invention, the projection apparatus further includes a light uniforming element disposed on the transmission path of the illumination beam and located between the illumination system and the light valve. In an embodiment of the invention, the light uniforming element is a light integration rod. In an embodiment of the invention, the light uniforming element includes at least one lens array.

In an embodiment of the invention, the projection apparatus further includes a field lens disposed on the transmission path of the illumination beam and located between the illumination system and the light valve, wherein the field lens is disposed on the transmission path of the image beam and located between the light valve and the projection lens.

In an embodiment of the invention, the illumination system includes a white light source.

In an embodiment of the invention, the illumination system includes a first light source, a second light source, and a light combining element. The first light source provides a first light color and a second light color, the second light source provides a third light color, and the light combining element reflects the first light color and the second light color of the first light source, and transmits the third light color of the second light source. In an embodiment of the invention, the light combining element includes a first reflective element and a second reflective element. The first reflective element and the second reflective element are disposed side by side and not intersecting. The first reflective element reflects the first light color, the second reflective element reflects the second light color, and the third light color passes through the first reflective element and the second reflective element. In an embodiment of the invention, each of the first light source and the second light source is a light emitting diode.

In an embodiment of the invention, the illumination system includes a first light source, a second light source, a third light source, and a light combining element. The first light source provides a first light color, the second light source provides a second light color, the third light source provides a third light color, and the light combining element reflects the first light color and the second light color, and transmits the third light color. In an embodiment of the invention, the light combining element includes a first reflective element and a second reflective element. The first reflective element and the second reflective element are cross disposed. The first reflective element reflects the first light color, the second reflective element reflects the second light color, and the third light color passes through the first reflective element and the second reflective element. In an embodiment of the invention, each of the first light source, the second light source, and the third light source is a light emitting diode.

Based on the above, the embodiments of the invention may have at least one of the following functions or advantages. In the projection apparatus, the lens of the projection lens closest to the light valve may be cut, thus, the dimension of the lens closest to the light valve may be smaller, and allow the distance between the projection lens and the relay lens to be closer, so that the size of the projection apparatus may be reduced. In the projection lens, the cutting ratio of the lens closest to the light valve is a distance from the first edge to the optical axis and a distance from the second edge to the optical axis greater than or equal to 0 and less than 1. In addition, the image beam from the light valve deviates from the optical axis of the lens closest to the light valve in a direction away from the first edge, allowing the projection lens to project a high quality image.

To make the aforesaid features and advantages of the invention more comprehensible, several embodiments accompanied with figures are illustrated in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic view of a projection apparatus according to an embodiment of the invention.

FIG. 1B is a schematic view of a lens of a projection lens in FIG. 1A closest to a light valve.

FIG. 1C is a schematic view of a relay lens in FIG. 1A.

FIG. 1D is a curve diagram drawn according to the data of Table 1.

FIG. 2 is a schematic view of a projection apparatus according to another embodiment of the invention.

FIG. 3 is a schematic view of a projection apparatus according to yet another embodiment of the invention.

FIG. 4 is a schematic view of a projection apparatus according to still another embodiment of the invention.

FIG. 5 is a schematic view of a projection apparatus according to still another embodiment of the invention.

FIG. 6 is a schematic view of a projection apparatus according to still another embodiment of the invention.

FIG. 7 and FIG. 8 respectively show illumination systems of different embodiments.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

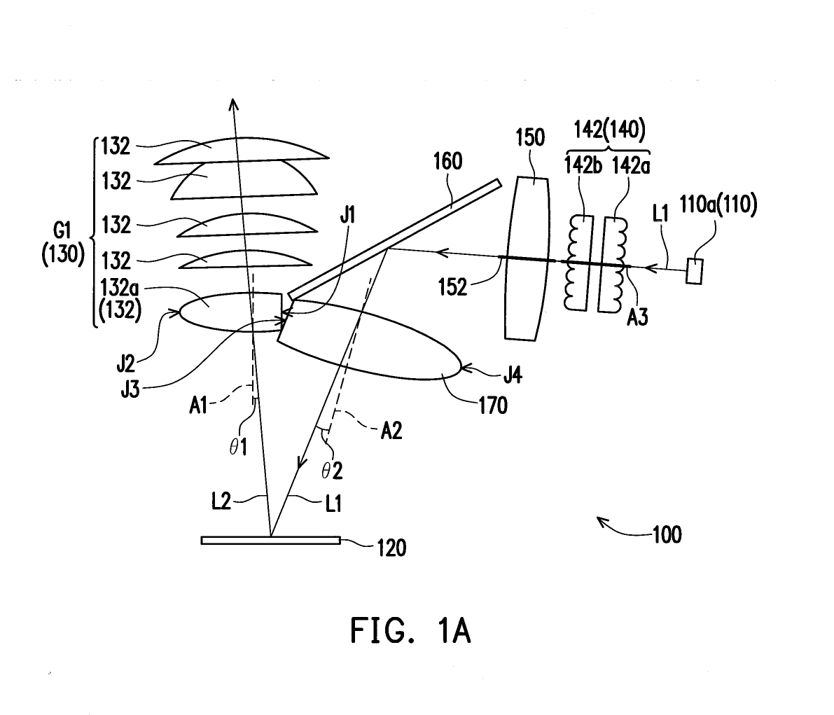

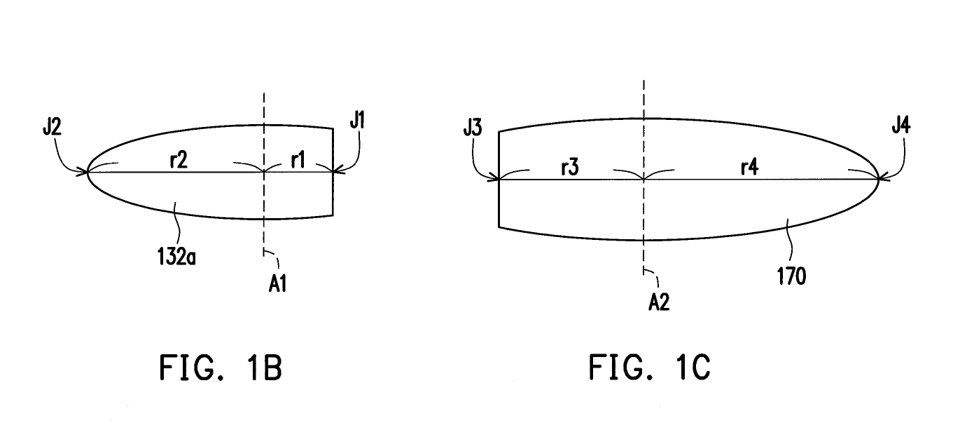

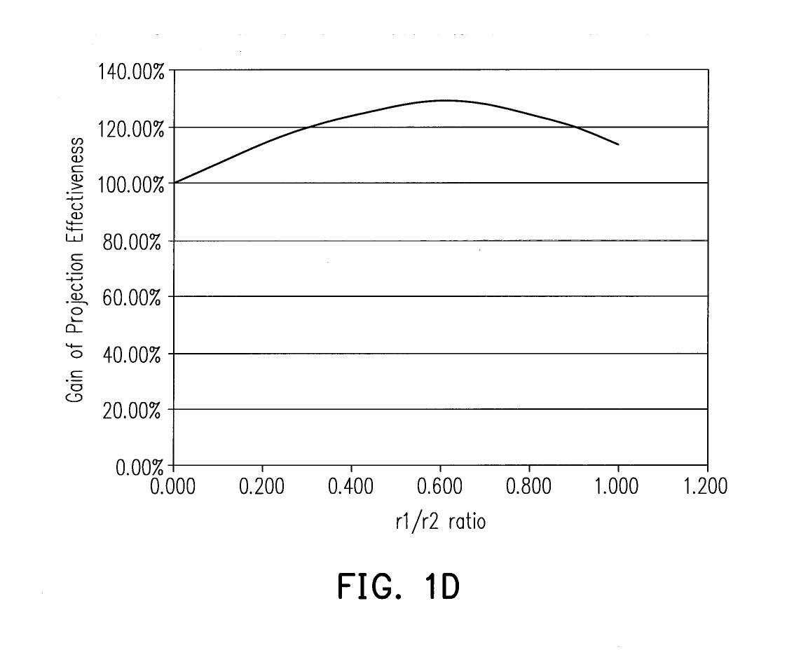

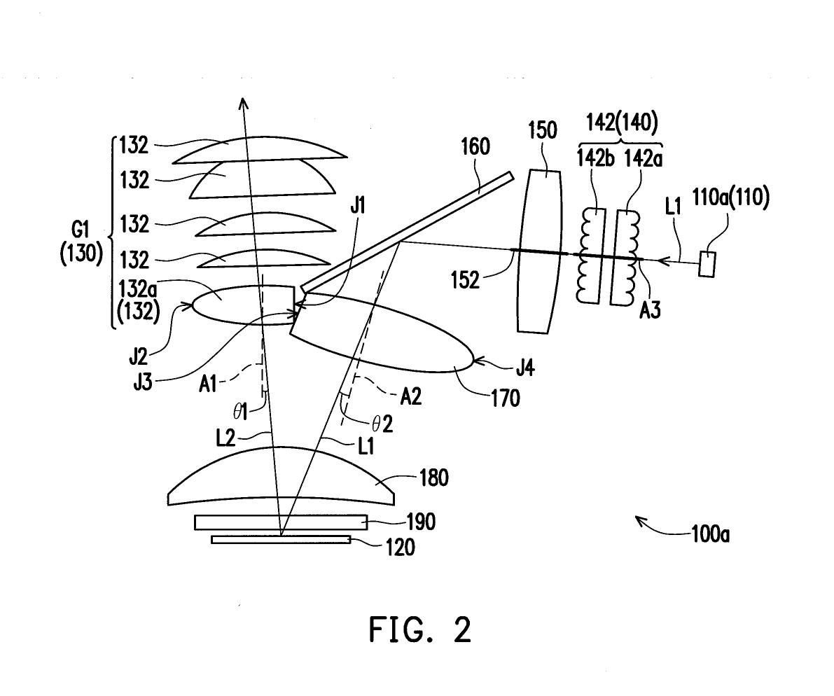

FIG. 1A is a schematic view of a projection apparatus according to an embodiment of the invention. Referring to FIG. 1A, the projection apparatus 100 of the embodiment includes an illumination system 110, a light valve 120, and a projection lens 130. The illumination system 110 provides an illumination beam L1. In the embodiment, the illumination system 110 includes at least one light source, and the light source may be a light emitting diode (LED), an ultra high pressure lamp (UHP lamp), or other suitable light sources.

In addition, the light valve 120 is disposed on a transmission path of the illumination beam L1, and is used to convert the illumination beam L1 into an image beam L2. In the embodiment, the light valve 120 is, for example, a digital micro-mirror device (DMD). However, in other embodiments, the light valve 120 may also be a liquid-crystal-on-silicon panel (LCOS panel).

In the embodiment, the projection apparatus 100 further includes a light uniforming element 140 disposed on the transmission path of the illumination beam L1 and located between the illumination system 110 and the light valve 120. In the embodiment, the light uniforming element 140 includes at least one lens array 142. Specifically, the lens array 142 includes two sub-lens-arrays 142a, 142b, which functions as uniforming the illumination beam L1 passing through the lens array 142 and adjusting the light shape of the illumination beam L1 transmitted to the light valve 120.

Specifically, if the light valve 120 is rectangular, the light shape of the illumination beam L1 transmitted to the light valve 120 is preferably rectangular. The method to adjust the light shape of the illumination beam L1 could be achieved through the light uniforming element 140. In addition, the projection apparatus 100 may also include a condenser lens 150 disposed on the transmission path of the illumination beam L1 and located between the light uniforming element 140 and the light valve 120. In the embodiment, an optical axis A3 of the light uniforming element 140 is, for example, parallel with an optical axis 152 of the condenser lens 150. That is to say, the optical axis A3 of the light uniforming element 140 and the optical axis 152 of the condenser lens 150 may be located in the same transmission path of the illumination beam L1. In the embodiment, the condenser lens 150 is mainly used to converge the illumination beam L1 passing through the light uniforming element 140, so as to maintain the light shape of the illumination beam L1 transmitted to the light valve 120. Thus, the illumination area and effectiveness on the light valve 120 illuminated by the illumination beam L1 could be maintained.

In addition, the projection apparatus 100 of the embodiment further includes a reflective element 160 disposed on the transmission path of the illumination beam L1 and located between the illumination system 110 and the light valve 120. The reflective element 160 is used to transmit the illumination beam L1 of the illumination system 110 to the light valve 120. In the embodiment, the reflective element 160 is, for example, a mirror, but according to the user requirement and design, the reflective element 160 may also be an optical element such as a total internal reflection prism to reflect the illumination beam L1 of the illumination system 110 to the light valve 120.

In the embodiment, the projection apparatus 100 includes a relay lens 170 disposed on the transmission path of the illumination beam L1 and located between the illumination system 110 and the light valve 120. In detail, the relay lens 170 is located between the reflective element 160 and the light valve 120, and is used to converge the illumination beam L1 reflected by the reflective element 160, so as to maintain the illumination area and effectiveness on the light valve 120 illuminated by the illumination beam L1.

Referring to FIG. 1A, the projection lens 130 is disposed on a transmission path of the image beam L2 and has a lens group G1, and the lens group G1 includes a plurality of lenses 132. Specifically, when the projection apparatus 100 is projecting an image, the light valve 120 will convert the illumination beam L1 to the image beam L2 and reflect the image beam L2 to the projection lens 130. Then, the image beam L2 is projected onto a screen (not shown) through the projection lens 130.

In detail, a lens 132a has an optical axis A1, a first edge J1, and a second edge J2. The first edge J1 and the second edge J2 are located on opposite sides of the optical axis A1, and a ratio of a distance r1 from the first edge J1 to the optical axis A1 and a distance r2 from the second edge J2 to the optical axis A1 is greater than or equal to 0 and less than 1, as shown in FIG. 1A and FIG. 1B, wherein FIG. 1B is a schematic diagram of the lens 132a of the projection lens 130 in FIG. 1A closest to the light valve 120. In FIG. 1B, as the ratio of the distance r1 from the first edge J1 to the optical axis A1 and the distance r2 from the second edge J2 to the optical axis A1 is smaller, it represents that the lens 132a has a smaller size, and vice versa. In the embodiment, the ratio of the distance r1 from the first edge J1 to the optical axis A1 and the distance r2 from the second edge J2 to the optical axis A1 of the lens 132a closest to the light valve 120 is between 0.2 and 0.6. The first edge J1 and the second edge J2 mentioned above are defined as bearing plane of lens 132a, and function as fixing the lens 132a, which is known to persons of ordinary knowledge in this art.

The following content describes an embodiment of the projection apparatus 100 as an example, which uses a cutting method to reduce the size of the lens 132a. It should be noted that, the invention is not limited to the data listed in Table 1. It should be known to those ordinary skilled in the art that various modifications and variations can be made to the structure of the invention without departing from the scope or spirit of the invention. Table 1 respectively shows the ratio of the distance r1 from the first edge J1 to the optical axis A1 and the distance r2 from the second edge J2 to the optical axis A1 of the lens 132a closest to the light valve 120 when adopting different values and generating values of the effectiveness of the overall projection brightness, and FIG. 1D is a curve diagram drawn according to the data of Table 1.

TABLE 1

| | Gain of Projection |
|---|---|
| r1/r2 | Effectiveness |
| 1.000 | 100.00% |
| 0.900 | 107.29% |
| 0.800 | 113.96% |
| 0.700 | 119.76% |
| 0.600 | 124.25% |
| 0.500 | 127.73% |
| 0.400 | 129.41% |
| 0.300 | 128.12% |
| 0.200 | 124.67% |
| 0.100 | 120.30% |
| 0.000 | 113.82% |

It can be known from Table 1 that when the ratio r1/r2 is 1, then the lens 132a has not been cut, and the gain of the projection effectiveness of the projection apparatus 100 is defined as 100%. When the ratio r1/r2 becomes smaller, it means that the lens 132a has been cut more, and the gain of the projection effectiveness of the projection apparatus 100 becomes greater. It should be noted that when the ratio r1/r2 is 0 (meaning that the lens 132a has been cut half). The gain of the projection effectiveness of the projection apparatus 100 still has better performance comparing to the lens 132a has not been cut.

In other words, when the lens 132a closest to the light valve 120 is cut, reducing the size of the projection apparatus, having no shadow in the projected image, and substantially achieving the brightness in the image of when the lens 132a was not cut must be considered. The better cutting ratio mentioned above could simultaneously reduce the size, allow no shadow in the projected image, and maintain the brightness in the projected image. In addition, since the lens 132a is cut, in order to let the projection lens 130 project the image beam L2 onto a screen without being influenced, to generate better projection quality, thus the image beam L2 from the light valve 120 of the embodiment needs to deviate from the optical axis A1 of the lens 132a, as shown in FIG. 1A.

In the embodiment, since the lens 132a is cut, the lens 132a will be asymmetrical. Thus, if the image beam L2 desires to be projected onto a screen by the projection lens 130 without being influenced by the cut lens 132a, the image beam L2 from the light valve 120 must deviate from the optical axis A1 of the lens 132a in a direction away from the first edge J1. In the embodiment, the image beam L2 deviates from the optical axis A1 of the lens 132a and passes through a side of the lens 132a, and the second edge J2 is located on that side. That is to say, the lens 132a is divided into two portions by the optical axis A1, wherein the image beam L2 does not pass through a portion of the remains of the cut lens 132a, but passes through another portion of the lens 132a not cut to project an image. It should be noted that the image beam L2 deviates from the optical axis A1 of the lens 132a at an angle θ1 within a range of three degrees.

In addition, to further reduce the size of the projection apparatus 100, and simultaneously provide a high quality projection, the projection apparatus 100 of the embodiment could also cut the relay lens 170, to make the relay lens 170 closer to the projection lens 130, so as to further reduce the size of the projection apparatus 100. Specifically, in the embodiment, the relay lens 170 has an optical axis A2, a third edge J3, and a fourth edge J4. The third edge J3 and the fourth edge J4 are located on opposite sides of the optical axis A2 of the relay lens 170, and the ratio of a distance r3 from the third edge J3 to the optical axis A2 of the relay lens 170 and a distance r4 from the fourth edge J4 to the optical axis A2 of the relay lens 170 is greater than or equal to 0 and less than 1, as shown in FIG. 1A and FIG. 1C, wherein FIG. 1C is a schematic diagram of the relay lens 170 in FIG. 1A. In FIG. 1C, as the ratio of the distance r3 from the third edge J3 to the optical axis A2 and the distance r4 from the fourth edge J4 to the optical axis A2 is smaller, it represents that the relay lens 170 has a smaller size, and vice versa. In the embodiment, the ratio r3/r4 preferably falls in a range between 0.4 and 0.5.

In the embodiment, the third edge J3 and the first edge J1 are opposite to each other, and the considerations in cutting the relay lens 170 are the same as the considerations in cutting the lens 132a closest to the light valve 120. The considerations are such as reducing the size of the projection apparatus, having no shadow in the projected image, and substantially achieving the brightness in the image when the relay lens 170 was not cut. The better cutting ratio could simultaneously reduce the size, allow no shadow in the projected image, and maintain the brightness in the projected image.

Similarly, in order to prevent the light shape of the illumination beam L1 transmitted to the light valve 120 from being influenced by the cut relay lens 170, the illumination beam L1 deviates from the optical axis A2 of the relay lens 170. That is to say, the illumination beam L1 deviates from the optical axis A2 of the relay lens 170 in a direction away from the third edge J3. In the embodiment, the illumination beam L1 deviates from the optical axis A2 of the relay lens 170 and passes through a side of the relay lens 170, wherein the fourth edge J4 is located on another side opposite to the optical axis A2 of the relay lens 170. That is to say, the relay lens 170 is divided into two portions by the optical axis A2, wherein the image beam L1 does not pass through a portion of the remains of the cut relay lens 170, but passes through another portion of the relay lens 170 not cut, to successfully transmit the light shape of the illumination beam L1 to the light valve 120. In the embodiment, the illumination beam L1 deviates from the optical axis A2 of the relay lens 170 at an angle θ2 within a range of three degrees.

It should be noted that, when the projection apparatus 100 of the embodiment adopting the aforementioned design, the overall size of the projection apparatus 100 may be 72 mm*36 mm=2592 mm2. Comparatively, the conventional projection apparatuses that do not cut the lens closest to the light valve but cut the relay lens have an overall size of 74 mm*55 mm=4070 mm2. In other words, the projection apparatus 100 of the embodiment has a 64% reduction in size when compared to a conventional projection apparatus by cutting the lens 132a of the projection lens 130 closest to the light valve 120. In addition, since the lens 132a of the projection lens 130 closest to the light valve 120 is cut, the projection lens 130 could be closer to the light valve 120. In other words, the projection lens 130 itself could be reduced in size, for example, an 18% reduction from 14.3 mm to 11.7 mm.

By simultaneously cutting the lens 132a of the projection lens 130 closest to the light valve 120 and the relay lens 170, besides reducing the overall size of the projection apparatus 100, the projection apparatus 100 could also have space to place the reflective element 160, to prevent the problem of light interference, reducing the chance of having shadow in the projection image. In addition, in order to let the image beam L2 successfully image on the screen, the degree at which the light valve 120 reflects the image beam L2 is optimized, so the image beam L2 that transmits to the projection lens 130 deviates from the axis of the lens 132a of the projection lens 130 closest to the light valve 120. Thus, the image beam L2 passes through certain area of the lens 132a but not the entire area of the lens 132a, so as to prevent low projection effectiveness because the lens 132a has been cut. In other words, besides the projection apparatus 100 of the embodiment having a smaller size, it also has highly effective optical projection quality.

Even though the embodiment mentioned above uses a cutting method to cause the lens 132a of the projection lens 130 closest to the light valve 120 and the relay lens 170 to form an asymmetrical shape, an integrally formed method may also achieve the formation of an asymmetrical shape. Thus, the lens 132a and the relay lens 170 produced by the method of integral formation also has the characteristics and functions mentioned above.

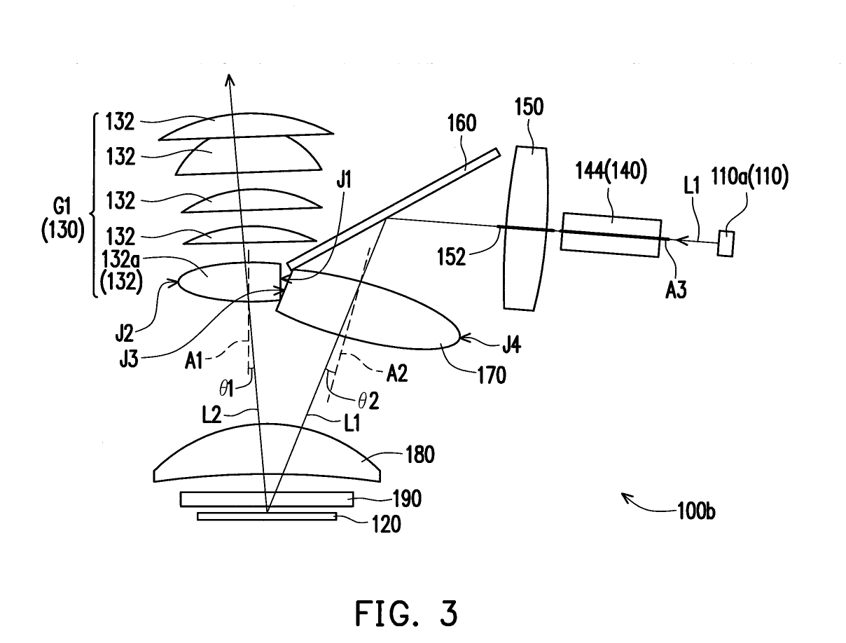

FIG. 2 is a schematic view of a projection apparatus according to another embodiment of the invention. Referring to FIG. 1A and FIG. 2, a projection apparatus 100a of the embodiment adopts a similar concept and a similar structure with the projection apparatus 100. The difference is the projection apparatus 100a further including a field lens 180 disposed on the transmission path of the illumination beam L1 and located between the illumination system 110 and the light valve 120, wherein the field lens 180 is disposed on the transmission path of the image beam L2 and located between the light valve 120 and the projection lens 130. In addition, a glass cover 190 could be disposed at the front of the light valve 120, to protect the light valve 120.

Since the projection apparatus 100a uses the same concept and structure of the projection apparatus 100, the projection apparatus 100a of the embodiment has the same advantages as the projection apparatus 100, and will not be repeated herein.

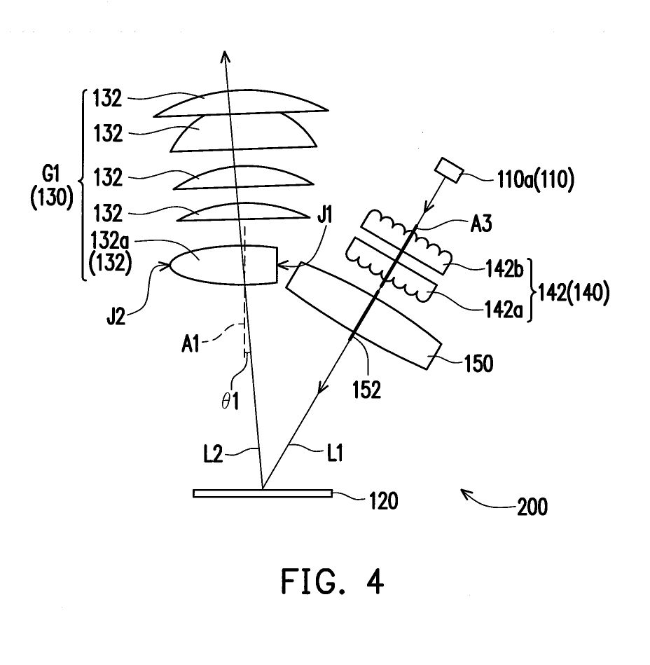

FIG. 3 is a schematic view of a projection apparatus according to yet another embodiment of the invention. Referring to FIG. 1A and FIG. 3, a projection apparatus 100b of the embodiment adopts a similar concept and a similar structure with the projection apparatus 100. The difference is the light uniforming element 140 of the projection apparatus 100b being a light integration rod 144. Specifically, the light integration rod 144 not only uniform the illumination beam L1 but also adjust the light shape of the illumination beam L1 to conform the shape of the light valve 120.

Similarly, since the projection apparatus 100b uses the same concept and structure of the projection apparatus 100, the projection apparatus 100b of the embodiment has the same advantages as the projection apparatus 100, and will not be repeated herein.

It should be noted that the projection apparatus 100b could also use the same structure as the projection apparatus 100a, which means that the projection apparatus 100b could also adopt the design of the field lens 180 and the glass cover 190. This depends on the requirements and design of the user, and the invention is not limited thereto.

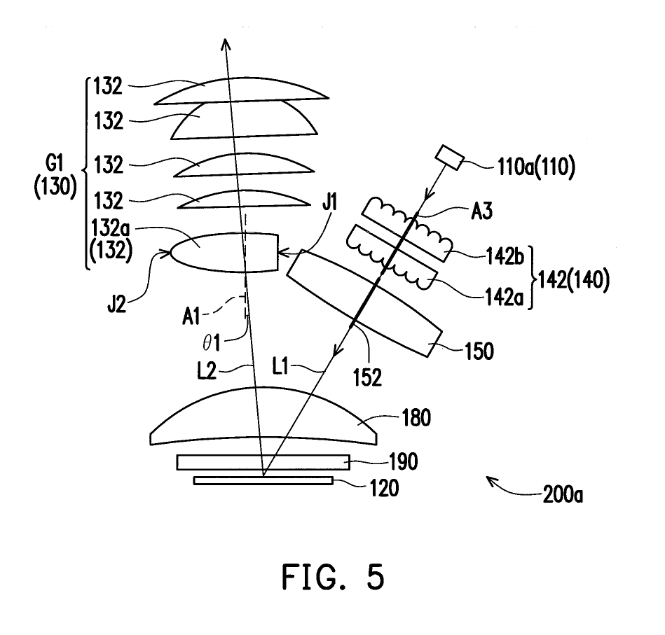

FIG. 4 is a schematic view of a projection apparatus according to still another embodiment of the invention. Referring to FIG. 1A and FIG. 4, a projection apparatus 200 of the embodiment adopts a similar concept and a similar structure with the projection apparatus 100. The difference is that the projection apparatus 200 does not have the reflective element 160. In other words, the illumination beam L1 of the illumination system 110 directly passes through the light uniforming element 140 and the condenser lens 150 to be transmitted to the light valve 120. The light path of the illumination beam of the projection apparatus 200 is different from the light path of the illumination beam of the projection apparatus 100.

Since the projection apparatus 200 of the embodiment uses the method of cutting the lens 132a of the projection lens 130 closest to the light valve 120 to reduce the overall size of the projection apparatus 200, it further avoids the conventional problem of interference of the image beam L2 between the lens 132a and the condenser lens 150, reducing the chance of having shadow in the projection image. Similarly, in order to let the image beam L2 successfully image on the screen, the degree at which the light valve 120 reflects the image beam L2 is optimized, so that the image beam L2 transmitted to the projection lens 130 deviates from the axis A1 of the lens 132a of the projection lens 130 closest to the light valve 120. Thus, the image beam L2 passes through certain area of the lens 132a but not the entire area of the lens 132a, so as to prevent low projection effectiveness due to the cut lens 132a. In other words, the projection apparatus 200 of the embodiment has the same advantages as the projection apparatus 100.

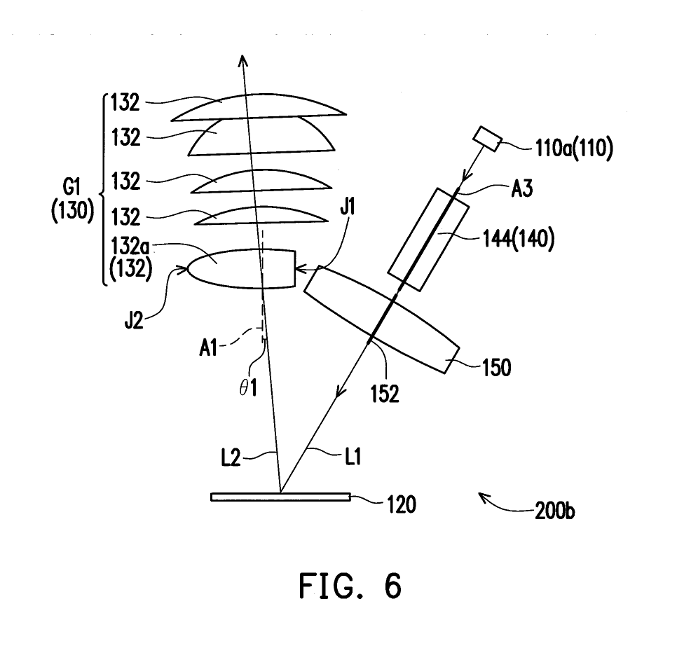

FIG. 5 is a schematic view of a projection apparatus according to still another embodiment of the invention. Referring to FIG. 4 and FIG. 5, a projection apparatus 200a of the embodiment adopts a similar concept and a similar structure with the projection apparatus 200. The difference is the projection apparatus 200a further including the field lens 180 disposed on the transmission path of the illumination beam L1 and located between the illumination system 110 and the light valve 120, wherein the field lens 180 is disposed on the transmission path of the image beam L2 and located between the light valve 120 and the projection lens 130. In addition, the glass cover 190 could be disposed at the front of the light valve 120 to protect the light valve 120.

Since the projection apparatus 200a uses the same concept and structure of the projection apparatus 200, the projection apparatus 200a of the embodiment has the same advantages as the projection apparatus 200, and will not be repeated herein.

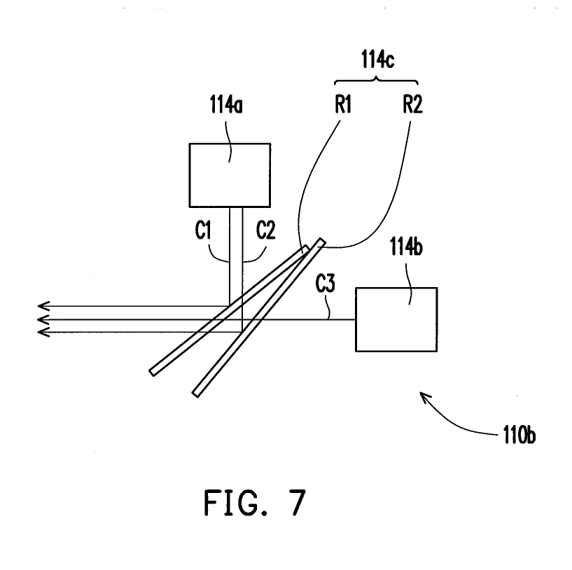

FIG. 6 is a schematic view of a projection apparatus according to still another embodiment of the invention. Referring to FIG. 4 and FIG. 6, a projection apparatus 200b of the embodiment adopts a similar concept and a similar structure with the projection apparatus 200. The difference is the light uniforming element 140 of the projection apparatus 200b being the light integration rod 144. Specifically, the light integration rod 144 not only uniform the illumination beam L1 but also adjust the light shape of the illumination beam L1 to conform the shape of the light valve 120.

Similarly, since the projection apparatus 200b uses the same concept and structure of the projection apparatus 200, the projection apparatus 200b of the embodiment has the same advantages as the projection apparatus 200, and will not be repeated herein.

It should be noted that the projection apparatus 200b could also use the same structure as the projection apparatus 200a. This means that the projection apparatus 200b could also adopt the design of the field lens 180 and the glass cover 190, depending on the requirements and design of the user. The invention is not limited thereto.

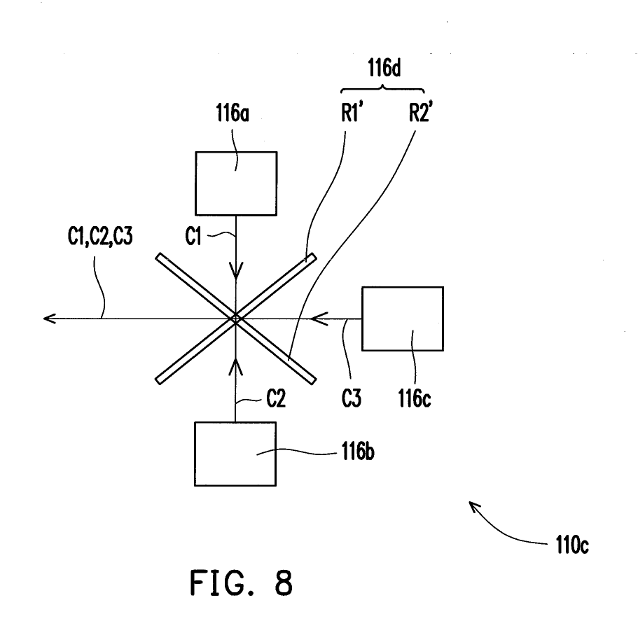

In addition, in the projection apparatuses 100, 100a, 100b, 200, 200a, and 200b, the illumination system 110 is, for example, a white light source 110a. In other embodiments, the illumination system 110 could also adopt an illumination system 110b and an illumination system 110c respectively shown in FIG. 7 and FIG. 8.

In the embodiment shown in FIG. 7, the illumination system 110b includes a first light source 114a, a second light source 114b, and a light combining element 114c. The first light source 114a provides a first light color C1 and a second light color C2. The second light source 114b provides a third light color C3. The light combining element 114c reflects the first light color C1 and the second light color C2 of the first light source 114a, and the third light color C3 of the second light source 114b passes through the light combining element 114c. Specifically, the light combining element 114c includes a first reflective element R1 and a second reflective element R2. The first reflective element R1 and the second reflective element R2 are disposed side by side and not intersecting, wherein the first reflective element R1 reflects the first light color C1, the second reflective element R2 reflects the second light color C2, and the third light color C3 passes through the first reflective element R1 and the second reflective element R2.

In the illumination system 110b, the first light source 114a is, for example, a light emitting diode emitting two colors, and the second light source 114b is, for example, a light emitting diode emitting one color. Specifically, the first light color C1, the second light color C2, and the third light color C3 may respectively be a red light, a blue light, and a green light. By way of the light combining element 114c, the first light color C1 and the second light color C2 could respectively be reflected by the first reflective element R1 and the second reflective element R2, and the third light color C3 could pass through the first reflective element R1 and the second reflective element R2, and thus these three light colors combines to white light.

Each of the first light source 114a and the second light source 114b of the illumination system 110b is, for example, an independent element, but in other embodiments, the illumination system, for example, adopts a single light source (not shown) that could emit three colors. The single light source combining the light combining element 114c with the first reflective element R1 and the second reflective element R2 could achieve substantially the same effects as the illumination system 110b.

In addition, other embodiments adopts a light combining element (not shown) with three reflective elements, wherein the three reflective elements are disposed side by side and not intersecting, and respectively reflect three light colors. Of course, the invention is not limited to a light source assembly structure of three colors.

In the embodiment shown in FIG. 8, the illumination system 110c includes a first light source 116a, a second light source 116b, a third light source 116c, and a light combining element 116d. The first light source 116a provides a first light color C1. The second light source 116b provides a second light color C2. The third light source 116c provides a third light color C3. The light combining element 116d reflects the first light color C1 and the second light color C2, and the third light color C3 passes through the light combining element 116d. Specifically, the light combining element 116d includes a first reflective element R1′ and a second reflective element R2′, wherein the first reflective element R1′ and the second reflective element R2′ are disposed as intersecting. The first reflective element R1′ reflects the first light color C1, the second reflective element R2′ reflects the second light color C2, and the third light color C3 passes through the first reflective element R1′ and the second reflective element R2′.

In the illumination system 110c, the first light source 116a is, for example, a light emitting diode emitting the red color, the second light source 116b is, for example, a light emitting diode emitting the blue color, and the third light source 116c is, for example, a light emitting diode emitting the green color. Similarly, by way of the light combining element 116d, the first light color C1 and the second light color C2 could respectively be reflected by the first reflective element R1′ and the second reflective element R2′, and the third light color C3 could pass through the first reflective element R1′ and the second reflective element R2′, and thus these three light colors combine to white light.

Each of the first light source 116a, the second light source 116b, and the third light source 116c of the illumination system 110c is, for example, an independent element, but in other embodiments, the illumination system, for example, adopts a single light source (not shown) emitting three colors. The single light source combining the light combining element 116d with the first reflective element R1′ and the second reflective element R2′ could achieve substantially the same effects as the illumination system 110c.

It should be noted that the aforementioned illumination systems (such as 110b, 110c) could also be used in any of the projection apparatuses 100, 100a, 100b, 200, 200a, and 200b, and will not be repeated herein.

To sum up, the embodiments of the invention include at least one of the following functions or advantages: First, the lens of the projection lens closest to the light valve of the projection apparatus could be cut. Thus, the dimensions of the lens closest to the light valve could be smaller, and could allow the distance between the projection lens and the relay lens to be closer, so that the size of the projection apparatus could be reduced. After cutting, the ratio of the distance from the first edge to the optical axis and a distance from the second edge to the optical axis is greater than or equal to 0 and less than 1. In addition, in order to let the projection lens to produce a good projection image, the image beam from the light valve deviates from the optical axis in a direction away from the first edge. Furthermore, to further reduce the size of the projection apparatus, and simultaneously provide a high quality projection, the projection apparatus of the embodiment could also cut the relay lens, to make the relay lens closer to the projection lens, so as to further reduce the size of the projection apparatus. After cutting, the ratio of a distance from the third edge to the optical axis and a distance from the fourth edge to the optical axis is greater than or equal to 0 and less than 1.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter. In addition, any one of the embodiments or claims of the invention is not necessarily to achieve all of the above-mentioned objectives, advantages or features. The abstract and the title herein are used to assist searching the documentations of the relevant patents, not to limit the claim scope of the invention. Each of the terms “first”, “second”, and “third” is only a nomenclature used to modify its corresponding element. These terms are not used to set up the upper limit or lower limit of the number of elements, wherein the element is, for example, a reflective element.

What is claimed is:

1. A projection apparatus, comprising:
an illumination system providing an illumination beam;
a light valve, disposed on a transmission path of the illumination beam to convert the illumination beam into an image beam; and
a projection lens, disposed on a transmission path of the image beam and having a lens group, the lens group comprising a plurality of lenses, wherein a lens of the plurality of lenses closest to the light valve has an optical axis, a first edge and a second edge, the first edge and the second edge are located on opposite sides of the optical axis, and a ratio of a distance from the first edge to the optical axis and a distance from the second edge to the optical axis is greater than or equal to 0 and less than 1.

2. The projection apparatus as claimed in claim 1, wherein the image beam deviates from the optical axis of the lens.

3. The projection apparatus as claimed in claim 2, wherein the image beam deviates from the optical axis of the lens at an angle within a range of three degrees.

4. The projection apparatus as claimed in claim 1, wherein the ratio is between 0.2 and 0.6.

5. The projection apparatus as claimed in claim 1, wherein the image beam deviates from the optical axis of the lens and passes through a side of the lens, and the second edge is located on the side.

6. The projection apparatus as claimed in claim 1, further comprising a relay lens, disposed on the transmission path of the illumination beam and located between the illumination system and the light valve.

7. The projection apparatus as claimed in claim 6, wherein the relay lens has an optical axis, a third edge, and a fourth edge, the third edge and the fourth edge are located on opposite sides of the optical axis of the relay lens, and a ratio of a distance from the third edge to the optical axis of the relay lens and a distance from the fourth edge to the optical axis of the relay lens is greater than or equal to 0 and less than 1.

8. The projection apparatus as claimed in claim 7, wherein the ratio is between 0.4 and 0.5.

9. The projection apparatus as claimed in claim 7, wherein the third edge and the first edge are opposite to each other.

10. The projection apparatus as claimed in claim 1, further comprising a reflective element, disposed on the transmission path of the illumination beam and located between the illumination system and the light valve, wherein the reflective element is capable of transmitting the illumination beam from the illumination system to the light valve.

11. The projection apparatus as claimed in claim 1, further comprising a light uniforming element, disposed on the transmission path of the illumination beam and located between the illumination system and the light valve.

12. The projection apparatus as claimed in claim 11, wherein the light uniforming element is a light integration rod.

13. The projection apparatus as claimed in claim 11, wherein the light uniforming element comprises at least one lens array.

14. The projection apparatus as claimed in claim 1, further comprising a field lens, disposed on the transmission path of the illumination beam and located between the illumination system and the light valve, wherein the field lens is disposed on the transmission path of the image beam and located between the light valve and the projection lens.

15. The projection apparatus as claimed in claim 1, wherein the illumination system comprises a white light source.

16. The projection apparatus as claimed in claim 1, wherein the illumination system comprises a first light source, a second light source, and a light combining element, the first light source providing a first light color and a second light color, the second light source providing a third light color, and the light combining element reflecting the first light color and the second light color of the first light source, and transmitting the third light color of the second light source.

17. The projection apparatus as claimed in claim 16, wherein the light combining element comprises a first reflective element and a second reflective element, the first reflective element and the second reflective element disposed side by side and not intersecting, wherein the first reflective element reflects the first light color, the second reflective element reflects the second light color, and the third light color passes through the first reflective element and the second reflective element.

18. The projection apparatus as claimed in claim 16, wherein each of the first light source and the second light source is a light emitting diode.

19. The projection apparatus as claimed in claim 1, wherein the illumination system comprises a first light source, a second light source, a third light source, and a light combining element, the first light source providing a first light color, the second light source providing a second light color, the third light source providing a third light color, and the light combining element reflecting the first light color and the second light color, and transmitting the third light color.

20. The projection apparatus as claimed in claim 19, wherein the light combining element comprises a first reflective element and a second reflective element, the first reflective element and the second reflective element cross disposed, wherein the first reflective element reflects the first light color, the second reflective element reflects the second light color, and the third light color passes through the first reflective element and the second reflective element.

21. The projection apparatus as claimed in claim 19, wherein each of the first light source, the second light source, and the third light source is a light emitting diode.
